(19) United States
(12) Patent Application Publication
(10) Pub. No.: US 2014/0153243 A1
(43) Pub. Date: Jun. 5, 2014

(54) ORNAMENTAL LIGHT SET

(71) Applicant: INLITEN, L.L.C., Glenview, IL (US)

(72) Inventor: Matthew P. Braasch, Chicago, IL (US)

(73) Assignee: INLITEN, L.L.C., Glenview, IL (US)

(21) Appl. No.: 14/098,006

(22) Filed: Dec. 5, 2013

Related U.S. Application Data
(60) Provisional application No. 61/733,812, filed on Dec. 5, 2012.

(51) Int. Cl. F21S 4/00

(52) U.S. Cl. CPC F21S 4/001
USPC 362/249.02; 362/249.01; 362/249.16

(57) ABSTRACT

An ornamental light set for use with a decorative pumpkin, in which the pumpkin defines an interior pumpkin space and a pumpkin top, includes a mounting assembly having a mounting face and a support member extending from the mounting face for mounting to the pumpkin top. A control assembly is coupled to the mounting assembly and includes a control circuit and one or more lights coupled to the control circuit. The one or more lights are suspended from the control circuit into the interior pumpkin space.

### BACKGROUND

The present invention relates to an ornamental light set, specifically an ornamental light set for use within a carved jack-o-lantern.

Many jack-o-lanterns are commonly illuminated by a small individual light or group of lights placed within and resting upon the bottom inside surface of the pumpkin. Such lights, including candles, often poorly illuminate the features carved into the pumpkin due both to the uneven surface of the pumpkin bottom and to the limited flexibility in positioning the lights within the pumpkin. Moreover, candles can be easily extinguished in the presence of wind, and the use of an open flame can present a fire hazard.

### SUMMARY

In one embodiment, an ornamental light set for use with a decorative pumpkin, in which the pumpkin defines an interior pumpkin space and a pumpkin top, includes a mounting assembly having a mounting face and a support member extending from the mounting face for mounting to the pumpkin top. A control assembly is coupled to the mounting assembly and includes a control circuit and one or more lights coupled to the control circuit. The one or more lights are suspended from the control circuit into the interior pumpkin space.

In one embodiment, an ornamental light set for use with a decorative pumpkin, in which the pumpkin defines an interior pumpkin space, includes a mounting assembly having a mounting face and a support member extending from the mounting face. A control assembly is coupled to the mounting assembly and includes a control circuit and an illumination face having one or more embedded lights coupled to the control circuit.

Other aspects of the invention will become apparent by consideration of the detailed description and accompanying drawings.

### BRIEF DESCRIPTION OF THE DRAWINGS

FIG. 1 is a side view of an ornamental light set.

FIG. 2 is a perspective view of a mounting assembly of the light set of FIG. 1.

FIG. 3 is a side view of another embodiment of an ornamental light set.

FIG. 4 is a perspective view of a control assembly of the light set of FIG. 1.

FIG. 5 is another side view of the light set of FIG. 1 with the lights extended.

FIG. 6 is an exploded view of a mounting assembly of the light set of FIG. 1 and a pumpkin top.

FIG. 7 is a side view of the mounting assembly of the light set of FIG. 6 coupled to the pumpkin top.

FIG. 8 is a perspective view of the control assembly of the light set of FIG. 6 coupled to the pumpkin top.

FIG. 9A is an exploded view of the light set and a pumpkin.

FIG. 9B is a side view of the light set coupled to a pumpkin top.

FIG. 10 is another perspective view of the light set of FIG. 1 with the lights in a bunched configuration.

FIG. 11 is a perspective view of an individual light bulb of the light set of FIG. 1.

FIG. 12 is a schematic of another embodiment of an ornamental light set installed within a pumpkin.

FIG. 13 is a perspective view of a mounting and control assembly of another embodiment of an ornamental light set.

FIG. 14 is a schematic of the light set of FIG. 13 coupled to a pumpkin.

FIG. 15 is a front perspective view of another embodiment of an ornamental light set.

FIG. 16 is a side perspective view of the ornamental light set of FIG. 15.

FIG. 17 is a rear perspective view of the ornamental light set of FIG. 15.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. And as used herein and in the appended claims, the terms “upper”, “lower”, “top”, “bottom”, “front”, “back”, and other directional terms are not intended to require any particular orientation, but are instead used for purposes of description only.

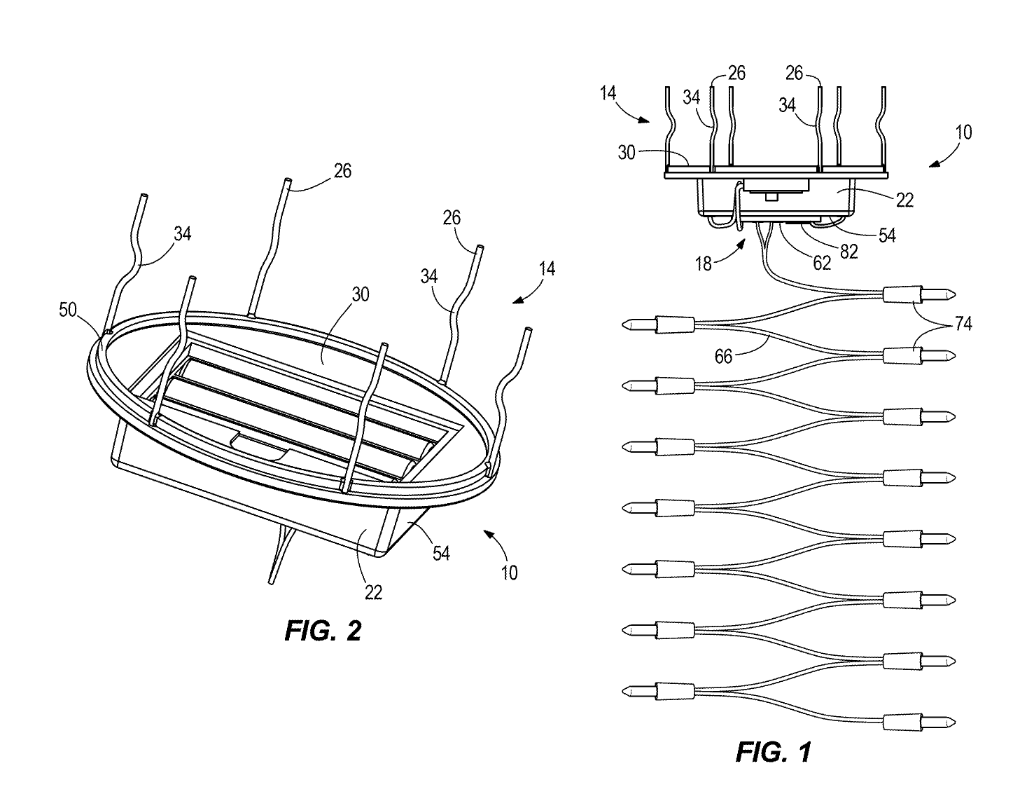

FIG. 1 illustrates an ornamental light set 10, which for purposes of the following description may be used in conjunction with a pumpkin, i.e., a jack-o-lantern, though the light set 10 is not necessarily limited to jack-o-lantern applications. The light set 10 includes a mounting assembly 14, a control assembly 18, and a power source 22.

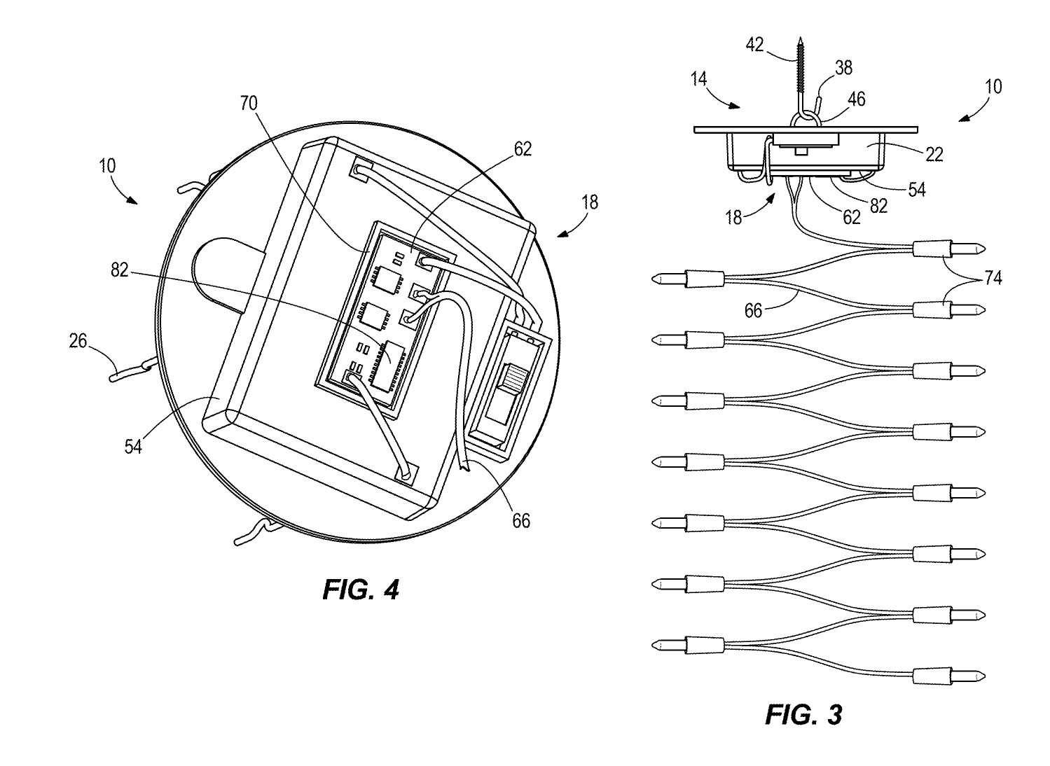

Referring also to FIG. 2, the mounting assembly 14 includes a plurality of support members, or legs 26, extending from a first mounting face 30 for insertion into a portion of a pumpkin, as will be described in greater detail below. Each leg 26 is formed with one or more detents 34, which improve engagement of the leg 26 with the pumpkin upon insertion. In some applications, the support members 26 take the form of pins, teeth, spikes, barbs, hooks, brackets, or other like members configured to penetrate the pumpkin and hold the light set 10 in place. For example, as shown in FIG. 3, a mounting hook 38 can be installed into the pumpkin with a threaded portion 42, and a corresponding mounting ring 46 can be placed on the mounting assembly 14 such that once the hook 38 is installed in the pumpkin, the light set 10 can be suspended by the mounting ring 46 coupled to the mounting hook 38. A single support member 26 can be used where sufficient to support the light set 10 and may be desirable in certain situations due to, for example, space constraints.

The support legs 26 are coupled to or adjacent to a mounting face periphery 50. In the illustrated embodiment, the mounting face periphery 50 is generally circular, but can, along with the mounting assembly 14 itself, be of any suitable shape for a particular application. As illustrated in FIG. 2, six legs 26 extend from the periphery 50, though more or fewer than six legs are within the scope of the invention. Each leg 26 is approximately one inch in length, but different lengths are contemplated for different applications. For example, the number and length of the legs 26 can be based on the size and weight of the particular light set 10 (described below) and/or the thickness or consistency of the pumpkin to which the mounting assembly 14 is secured, i.e., if the light set 10 is heavier, additional support members can be used to help support the additional weight, or if the pumpkin wall is relatively thin, support members shorter in length can be used to hinder inadvertent puncturing through the pumpkin.

The first mounting face 30 is in communication with a compartment 54 for containing the power source 22. In the illustrated embodiment, the power source 22 is a battery pack, such as a rechargeable battery pack. In other embodiments the power source 22 may include chargeable elements coupled to a source of “green” power such as wind or solar through a solar cell (not shown). In still other embodiments, power to the ornamental light set 10 may be provided through an AC power connection, e.g., from a traditional wall outlet, or with a 12 or 24 VDC or similar low voltage power supply (not shown).

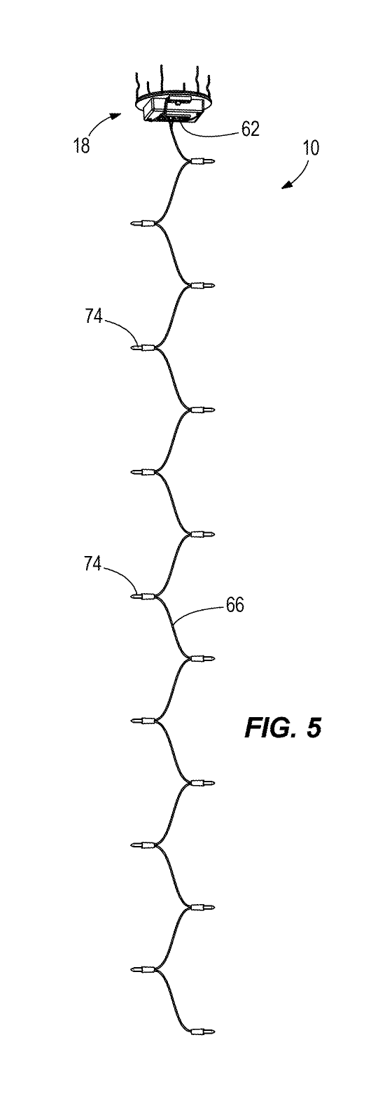

Referring to FIG. 4, the control assembly 18 includes a control circuit 62 and associated lights in the form of a light strand 66. The control circuit 62 is affixed to an outer wall 70 of the compartment 54 and electrically coupled to the power source 22. The light strand 66 is coupled to the control circuit 62 or to the surrounding outer wall 70, and can include a plurality of individual light bulbs 74, which are preferably light emitting diodes (LEDs) but alternative light sources and/or types, (e.g. incandescent, single-colored, multi-colored, color changing, etc.) are considered within the scope of the invention. As shown in FIGS. 3 and 5, the light strand 66 is coupled to and suspended from the control circuit 62. The light strand 66 can have any number of individual bulbs 74 and can be of any length desired.

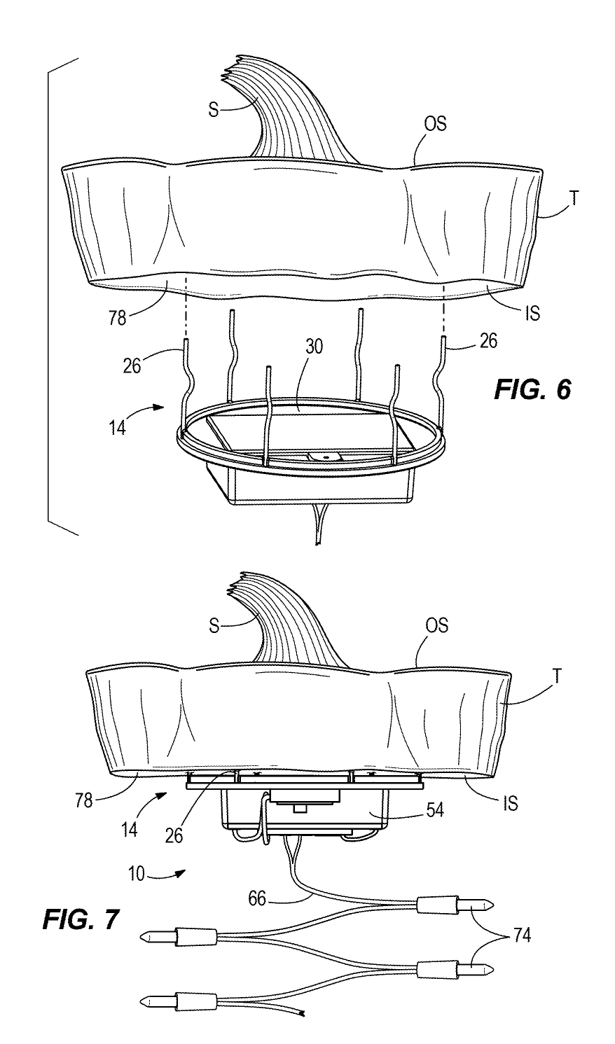

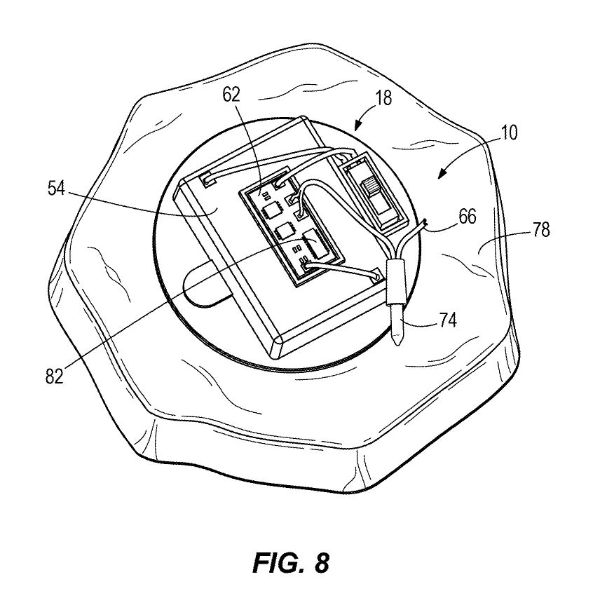

With reference to FIGS. 6 and 7, the installation of the light set 10 into a pumpkin top is illustrated. The pumpkin defines an interior pumpkin space, or cavity, and a pumpkin top T. An outer side OS of the pumpkin top T includes a pumpkin stem S, and an inner side IS of the pumpkin top T consists of the pulp and presents an engagement surface 78 for the mounting assembly 14. The user mounts the mounting assembly 14 to the inner side IS of the pumpkin top T by applying pressure to the mounting assembly 14 or to individual legs 26 to penetrate the support legs 26 into the engagement surface 78. FIG. 7 illustrates the installed light set 10 with the support legs 26 inserted into the inner side IS of the pumpkin top T. When engaged, the mounting assembly 14 is adjacent to the inner side IS. As shown in FIG. 8, the light set 10 as installed supports its own weight, to include the light strand 66 with up to approximately ten individual lights 74. To remove the light set 10, the user simply grasps the mounting assembly 14 and pulls the support legs 26 out of the inner side IS of the pumpkin top T.

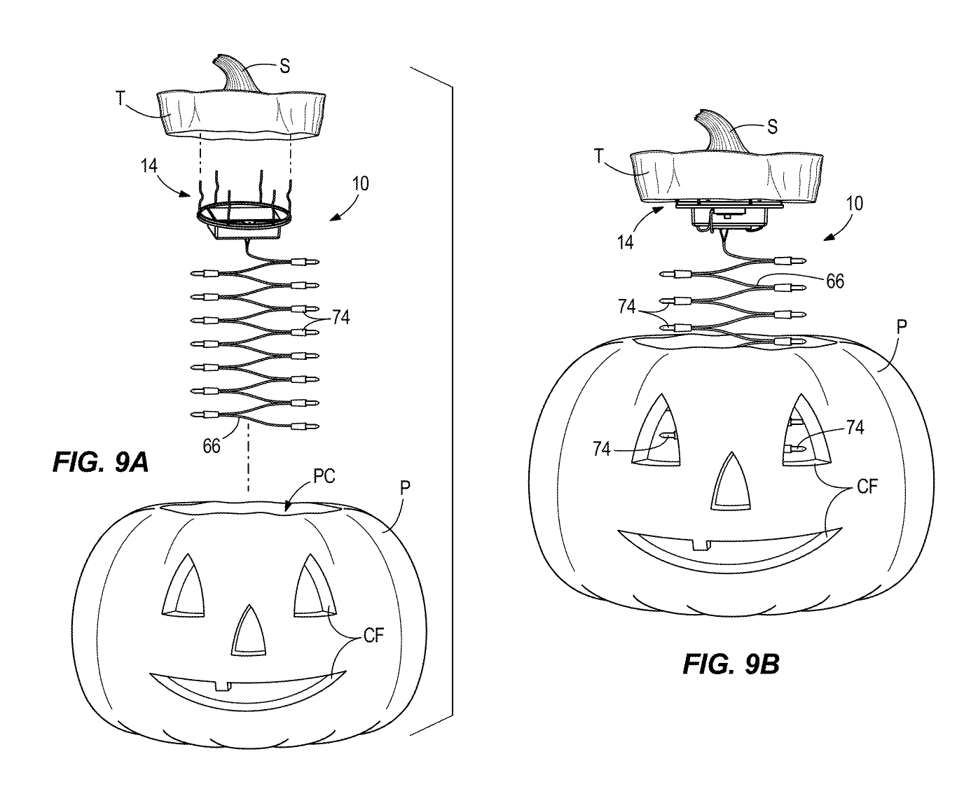

Referring also to FIGS. 9A-9B, with the mounting assembly 14 installed into the pumpkin top T as described above, the user places the pumpkin top T back onto the pumpkin P, which suspends the light strand 66 in the pumpkin cavity PC, with the light bulbs 74 illuminating the interior of the carved pumpkin P when the control assembly 18 applies power from the power source 22. With multiple lights 66 suspended throughout the pumpkin cavity PC, an improved level of illumination of the cavity is achieved when compared to a traditional method of illumination, such as a candle. This enhances the externally-viewed features CF of the jack-o-lantern P.

The control circuit 62 is configured to selectively provide power to the light strand 66 from the battery pack 22 and also to provide aural and visual effects. For example, an adjustable timer 82 (FIGS. 1 and 4) in cooperation with the control circuit 62 can control the lighting of the individual lights 74 for different operating modes. Specifically, a first mode provides constant power to the light strand 66 and the light bulbs 74 shine steadily. A second mode provides intermittent power to the light strand 66 such that the light bulbs 74 strobe, in unison, at an adjustable frequency set by the timer 82. A third mode provides intermittent power to the individual light bulbs 74 such that a flashing or twinkling effect is achieved by the light strand 66. A fourth mode provides various levels of power to the light strand 66 such that a repeated fading effect is achieved. In the fourth mode, the light bulbs 74 may begin with high intensity illumination and fade out until the bulbs 74 are not lit. In yet other modes, if the lights are color-changing, the lights may change color continuously or with intermittent power, or they may be pre-set to one of several colors. In addition, the timer 82 is used to operate the light set 10 for selectable hours of the day, regardless of operating mode. For instance, the power source 22, controlled by the control circuit 62, can power the light strand 66 for a predetermined number of hours (e.g. 6 hours at night), and keep the light strand 66 un-powered for the remaining part of the day.

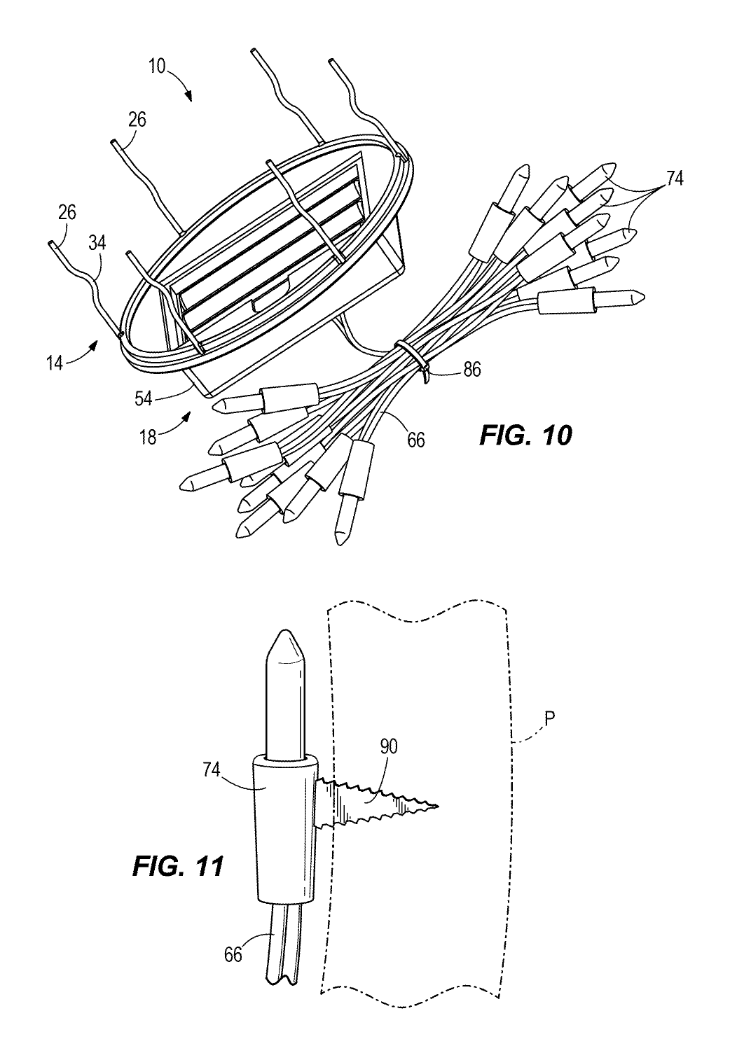

With reference to FIG. 10, in order to achieve greater positioning control of the light strand 66, a twist tie, or gathering device 86 permits the user to bunch individual light bulbs 74 up at a desired height. For example, the user can use the tie 86 to bunch the light bulbs 74 closer to the mounting assembly 14 to accommodate smaller pumpkins

In some applications, the individual light bulbs 74 can include individual mounting members, such as a spike 90, attached or integrally formed with each light bulb 74, as shown in FIG. 11. The spike 90 allows for the user to selectively mount individual bulbs 74 of the light set 10 to particular areas of the carved pumpkin P For example, the user can place a light bulb 74 directly behind each of the cutouts, or “eyes,” CF of a jack-o-lantern, using the mounting spike 90 to affix the light bulb 74 to the pumpkin P on the inside to specifically light up the targeted area of the jack-o-lantern.

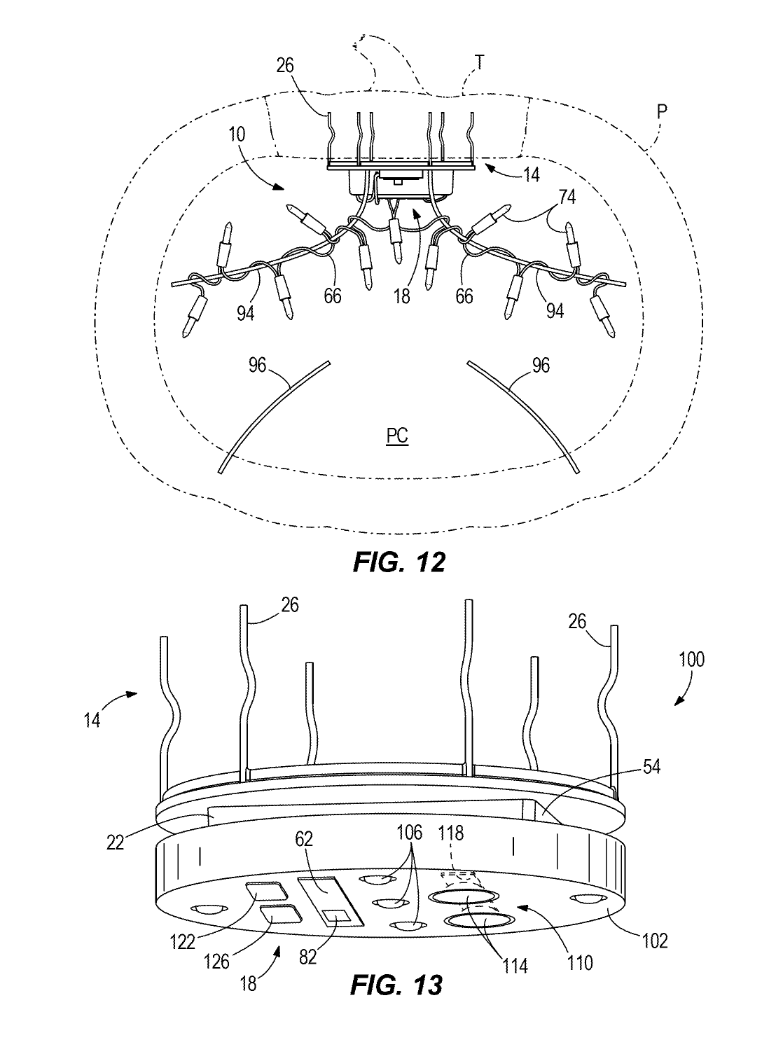

With reference to FIG. 12, in some embodiments the light set 10 can include a support frame 94 for positioning the string of lights 66, or individuals lights 74, in a more focused manner. The support frame 94 can, for example, take the form of a plurality of bendable wires extending from the mounting assembly 14 such that the user can drape or affix the lights 66 to overcome the positional limitations of gravity when suspended directly below the control assembly 18. Alternatively, individual positioning members 96, e.g., in the form of wires or rods, can be secured to the inside surface of the pumpkin cavity PC at any desired location and the individual lights 74 or portions of the light strand 66 affixed accordingly such that the lights can be positioned for pinpoint lighting.

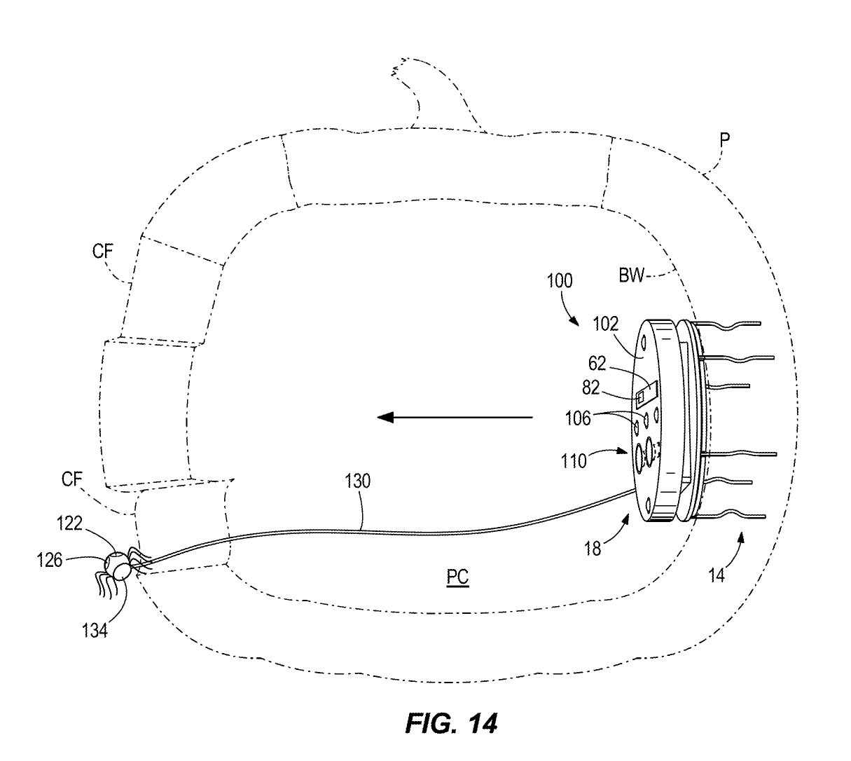

FIG. 13 illustrates an alternative embodiment of a light set 100, in which the control assembly 18 includes an illumination face 102 embedded with integral lights 106 in place of, or in addition to, the light strand 66 previously described. The integral lights 106 can be LEDs formed into or extending through the face 102 and drawing power from the power source 22. The illumination face 102 as illustrated is directed substantially downward and away from the pumpkin top T, but in other embodiments the face or a portion thereof may be formed having a surface facing frontward or in another direction to provide primary illumination in that direction. In this regard, although the illustrated embodiments are shown with the light set 10 attached to the pumpkin top T, the light sets 10, 100 are not limited to placement at or near the pumpkin top T, but can be located anywhere within the pumpkin P For example, with the embodiment illustrated in FIG. 14, the light set 100 can be mounted inside the carved pumpkin P on a back wall BW, directly illuminating the cutout features CF. The light set 100 is operable in any of the modes previously identified with respect to lights set 10 and functional with any and all of the components previously described with respect to the light set 10.

With further reference to FIG. 13, the light set 100 also includes a speaker assembly 110. The speaker assembly 110 includes speakers 114 and a driver circuit 118 with memory coupled to the control circuit 62. The driver circuit 118 includes preloaded or recorded sounds to be played through the speakers 114 (e.g. spooky Halloween sounds). In addition, the light set 100 can include a motion detector 122 and/or a light sensor 126 integrated into the illumination face 102 and disposed to detect movement and/or light near the pumpkin P, as shown in FIG. 14. In some applications, the motion detector 122 and/or light sensor 126 can be positioned externally of the pumpkin cavity PC and electrically coupled to the control assembly 18 through a wire 130. As illustrated in FIG. 14, in such applications the motion detector 122 and/or light sensor 126 can be incorporated with a decorative Halloween element, such as an artificial spider 134, to disguise the presence of the sensors 122, 126. Wireless communications between the sensors 122, 126 and the control assembly 18 are also within the scope of the invention.

The motion detector 122 sends a signal to the control circuit 62 upon detecting motion near the pumpkin, and the light sensor 126 sends a signal to the control circuit 62 depending on the level of ambient light. In response to either motion or a predetermined level of ambient light, the speakers 114 can play the preloaded or recorded sounds, and the control assembly 18 can activate the lights 106 in the manner previously described. The motion detector 122 and the light sensor 126 provide the light sets 10, 100 a greater level of interaction with the surrounding environment.

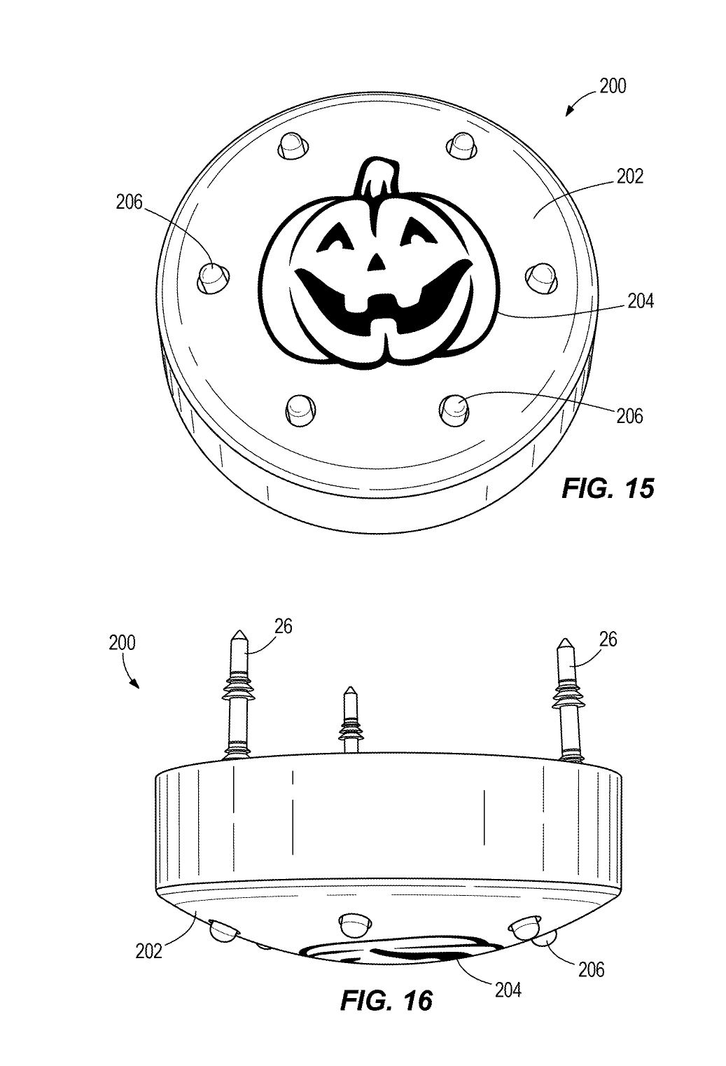

FIGS. 15 and 16 illustrate an additional embodiment of a light set 200, in which the control assembly includes an illumination face 202 having a design or other Halloween-themed feature 204 and embedded with integral lights 206, such as LEDs, formed into or extending through the face 202. The illumination face 202 as illustrated is directed substantially downward and away from the pumpkin top T (not shown), but in other embodiments the face 202 or a portion thereof may be formed having a surface facing frontward or in another direction to provide primary illumination in that direction. As with the light sets 10, 100, the light set 200 is not limited to placement at or near the pumpkin top T, but can be located anywhere within the pumpkin P, e.g., inside the carved pumpkin P on a back wall BW, directly illuminating the cutout features CF (see FIG. 14).

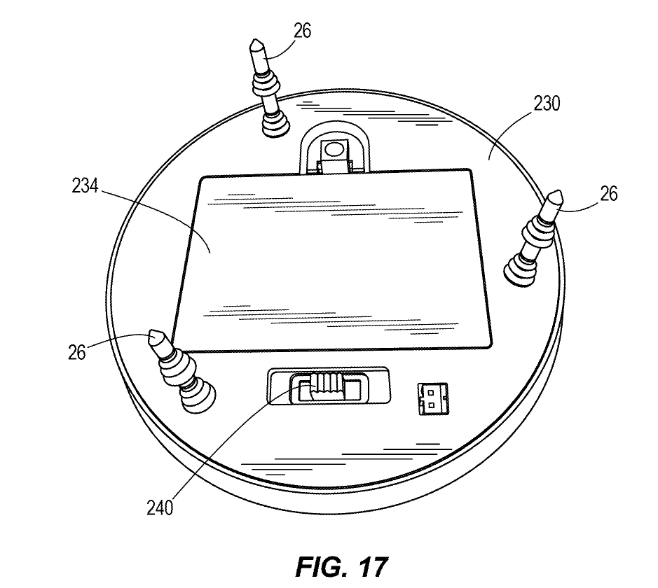

Referring also to FIG. 17, a rear mounting face 230 includes support legs 26, an access door 234 for accessing portions of the control assembly and/or the power source, and a switch 240 for changing the mode of operation of the light set 200. The light set 200 is operable in any of the modes previously identified with respect to lights sets 10, 100, including a steady level of light and a strobing effect. An automatic timer can be used to operate the light set 200 for selectable hours of the day or for a selectable time period in any of the available modes of operation. The light set 200 is operable and functional with any and all of the components previously described with respect to the light sets 10, 100, including a speaker assembly such as speaker assembly 110, a motion detector such as motion detector 122, or a light sensor such as light sensor 126 (see FIG. 14).

The light sets 10, 100, 200, including the mounting assembly 14, control assembly 18, and the light strand 66, can be formed of any material suitable for the operational environment, such as, for example, plastic.

The above described embodiments can be utilized with a decorative pumpkin, either real or artificial, such as those made from foam, plastic, or the like. The mounting assembly 14 can be installed into the artificial pumpkin in the same manner as a real pumpkin. Alternatively, the mounting assembly 14 can be integrally formed into an artificial pumpkin such that all of the features of the previously described embodiments are present in a single decorative unit.

Various features and advantages of the invention are set forth in the following claims.

We claim:

1. An ornamental light set for use with a decorative pumpkin, the pumpkin defining an interior pumpkin space and a pumpkin top, the light set comprising:
a mounting assembly having a mounting face and including a support member extending from the mounting face for mounting to the pumpkin top; and
a control assembly coupled to the mounting assembly and including
a control circuit, and
one or more lights coupled to the control circuit, wherein the one or more lights are suspended from the control circuit into the interior pumpkin space.

2. The light set of claim 1, wherein the support member is formed with one or more detents.

3. The light set of claim 1, wherein the support member is in the form of a rod.

4. The light set of claim 1, wherein the support member is in the form of a hook.

5. The light set of claim 1, wherein the support member is barbed.

6. The light set of claim 1, wherein the support member is a first support member, and further including a second support member extending from the mounting face for mounting to the pumpkin top.

7. The light set of claim 1, further including a power source derived from one of solar and wind power.

8. The light set of claim 1, wherein the one or more lights are in the form of a light strand having a plurality of individual light bulbs.

9. The light set of claim 1, wherein the control circuit is electrically coupled to an adjustable timer, wherein the adjustable timer controls the lighting of the one or more lights.

10. The light set of claim 1, wherein at least one of the one or more lights includes a mounting member formed integrally as one piece with the at least one light.

11. The light set of claim 1, further including a support frame positioned within the interior pumpkin space to support at least one of the one or more lights.

12. The light set of claim 11, wherein the support frame is coupled to the mounting assembly.

13. The light set of claim 11, wherein the support frame comprises one or more bendable wires.

14. An ornamental light set for use with a decorative pumpkin, the pumpkin defining an interior pumpkin space, the light set comprising:
a mounting assembly having a mounting face and including a support member extending from the mounting face; and
a control assembly coupled to the mounting assembly and including
a control circuit, and
an illumination face having one or more embedded lights coupled to the control circuit.

15. The light set of claim 14, wherein the one or more embedded lights are LEDs.

16. The light set of claim 14, wherein the illumination face is directed away from the mounting face.

17. The light set of claim 14, wherein the one or more embedded lights are a plurality of lights forming a pattern in the illumination face.

18. The light set of claim 14, wherein the support member is barbed.

19. The light set of claim 14, further including one or more speakers coupled to the control circuit.

20. The light set of claim 14, further including a motion detector coupled to the control circuit, wherein the one or more embedded lights operate upon detection of motion.
